(19) United States
(12) Patent Application Publication
(10) Pub. No.: US 2025/0219069 A1
(43) Pub. Date: Jul. 3, 2025

(54) FLUORINATED LITHIUM-RICH AND MANGANESE-BASED OXIDE POSITIVE ELECTRODE MATERIALS FOR BATTERIES THAT CYCLE LITHIUM IONS AND METHODS OF MANUFACTURING THE SAME

(71) Applicants: GM GLOBAL TECHNOLOGY OPERATIONS LLC, Detroit, MI (US); Ohio State Innovation Foundation, Columbus, OH (US)

(72) Inventors: Devendrasinh DARBAR, Sterling Heights, MI (US); Gongshin QI, Troy, MI (US); Mengyuan CHEN, Madison Heights, MI (US); Xiaosong HUANG, Novi, MI (US); Junbin CHOI, Columbus, OH (US); Jung Hyun KIM, Plain City, OH (US)

(21) Appl. No.: 18/396,859

(22) Filed: Dec. 27, 2023

(51) Int. Cl. H01M 4/505; C01G 53/00; H01M 4/02; H01M 4/13915; H01M 4/525; H01M 10/0525; H01M 10/0567; H01M 10/0568; H01M 10/0569

(52) U.S. Cl. CPC H01M 4/505; C01G 53/50; H01M 4/13915; H01M 4/525; H01M 10/0525; H01M 10/0567; H01M 10/0568; H01M 10/0569; C01P 2002/20; C01P 2002/54; C01P 2006/40; H01M 2004/028; H01M 2220/20; H01M 2300/0034; H01M 2300/0037

(57) ABSTRACT

A positive electrode for a battery that cycles lithium ions includes a fluorinated lithium-rich and manganese-based oxide (LMR) material. The fluorinated LMR material has the formula: Li₁₊ₓMe₁₋ₓO_{2-y}F_{y}, wherein: Me is a transition metal selected from the group consisting of Co, Ni, Mn, Fe, Al, V, Mo, Nb, Zr, Zn, Mg, Cu, Ti, and W; Me includes, on an atomic basis, greater than or equal to 50% Mn; x is greater than 0 and less than or equal to 0.33; and y is greater than 0 and less than or equal to 0.1.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to positive electrodes for batteries that cycle lithium ions, and more particularly to positive electrodes including fluorinated lithium-rich and manganese-based oxides as electroactive materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. Layered lithium-rich and manganese-based oxides (LMR) are attractive candidates for electroactive materials of positive electrodes due to their relatively high capacity (e.g., >250 mAh/g), thermal stability, and relatively low cost. However, LMR has been found to exhibit voltage decay, low coulombic efficiency, and irreversible capacity loss after repeated charge and discharge cycles.

### SUMMARY

A positive electrode for a battery that cycles lithium ions, in accordance with one or more embodiments of the present disclosure, comprises a fluorinated lithium-rich and manganese-based oxide (LMR) material. The fluorinated LMR material has the formula: Li₁₊ₓMe₁₋ₓO_{2-y}F_{y}, where Me is a transition metal selected from the group consisting of Co, Ni, Mn, Fe, Al, V, Mo, Nb, Zr, Zn, Mg, Cu, Ti, and W; Me comprises, on an atomic basis, greater than or equal to 50% Mn; x is greater than 0 and less than or equal to 0.33; and y is greater than 0 and less than or equal to 0.1.

In embodiments, the y may be greater than or equal to 0.005 and less than or equal to 0.08.

The fluorinated LMR material may have a layered crystal structure including a transition metal layer, an oxygen layer, and a lithium layer, and wherein fluorine ions in the fluorinated LMR material are present at anion sites within the oxygen layer.

The fluorinated LMR material may have the formula: LiₐNi_{b}Mn_{c}O_{2-y}F_{y}, wherein: a is greater than or equal to 1.1 and less than or equal to 1.2; b is greater than or equal to 0.25 and less than or equal to 0.4; c is greater than or equal to 0.6 and less than or equal to 0.75; and y is greater than or equal to 0.005 and less than or equal to 0.08.

A battery that cycles lithium ions, in accordance with one or more embodiments of the present disclosure, comprises a negative electrode, a positive electrode, and an electrolyte infiltrating the positive electrode. The negative electrode comprises an electroactive negative electrode material. The positive electrode comprises a fluorinated lithium-rich and manganese-based oxide (LMR) material. The fluorinated LMR material has the formula: Li₁₊ₓMe₁₋ₓO_{2-y}F_{y}, wherein: Me is a transition metal selected from the group consisting of Co, Ni, Mn, Fe, Al, V, Mo, Nb, Zr, Zn, Mg, Cu, Ti, and W; Me comprises, on an atomic basis, greater than or equal to 50% Mn; x is greater than 0 and less than or equal to 0.33; and y is greater than 0 and less than or equal to 0.1. The electrolyte comprises an organic solvent and a lithium salt in the organic solvent.

In embodiments, the y may be greater than or equal to 0.005 and less than or equal to 0.08.

The fluorinated LMR material may have a layered crystal structure including a transition metal layer, an oxygen layer, and a lithium layer, and wherein fluorine ions in the fluorinated LMR material are present at anion sites within the oxygen layer.

The fluorinated LMR material may have the formula: LiₐNi_{b}Mn_{c}O_{2-y}F_{y}, wherein: a is greater than or equal to 1.1 and less than or equal to 1.2; b is greater than or equal to 0.25 and less than or equal to 0.4; c is greater than or equal to 0.6 and less than or equal to 0.75; and y is greater than or equal to 0.005 and less than or equal to 0.08.

The organic solvent may comprise fluoroethylene carbonate (FEC) and diethyl carbonate (DEC).

The lithium salt may comprise lithium hexafluorophosphate (LiPF₆).

The electrolyte may further comprise lithium difluorophosphate (LiPO₂F₂).

In some embodiments, the electroactive negative electrode material may comprise a silicon oxide-based material and a carbon-based material.

In other embodiments, the electroactive negative electrode material may comprise, by weight, greater than 97% lithium.

A method of manufacturing a positive electrode for a battery that cycles lithium ions, in accordance with one or more embodiments of the present disclosure, comprises (a) mixing a non-fluorinated lithium-rich and manganese-based oxide (LMR) material with a fluorine-containing solution comprising a fluorine compound in a first solvent to form a precursor mixture, (b) removing the first solvent from the precursor mixture to form a fluorinated lithium-rich and manganese-based oxide (LMR) material, (c) mixing the fluorinated LMR material with a polymer binder and a second solvent to form a slurry, (d) depositing the slurry on a substrate, and then (e) removing the second solvent from the slurry to form the positive electrode. The fluorinated LMR material has the formula: Li₁₊ₓMe₁₋ₓO_{2-y}F_{y}, wherein: Me is a transition metal selected from the group consisting of Co, Ni, Mn, Fe, Al, V, Mo, Nb, Zr, Zn, Mg, Cu, Ti, and W; Me comprises, on an atomic basis, greater than or equal to 50% Mn; x is greater than 0 and less than or equal to 0.33; and y is greater than 0 and less than or equal to 0.1.

The y may be greater than or equal to 0.005 and less than or equal to 0.08.

The fluorine compound may comprise ammonium fluoride (NH₄F), titanium fluoride (TiF₄), lithium fluoride (LiF), or a combination thereof.

The first solvent may comprise acetone.

The first solvent may be removed from the precursor mixture by heating the precursor mixture at a temperature of greater than or equal to 30 degrees Celsius and less than or equal to 150 degrees Celsius.

The method may further comprise, prior to step (c), heating the fluorinated LMR material at a temperature of greater than or equal to 300° C. and less than or equal to 600° C. for a duration of greater than or equal to 1 hour and less than or equal to 12 hours.

The method may further comprise preparing the non-fluorinated LMR material by mixing a transition metal source with a lithium source to form a mixture, and heating the mixture to form the non-fluorinated LMR material. The transition metal source may comprise a transition metal carbonate (MeCO₃), a transition metal hydroxide (Me(OH)₂), or a combination thereof, and the lithium source may comprise lithium carbonate (Li₂CO₃), lithium carbonate (LiOH), or a combination thereof.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

FIG. 4 is a plot of Specific Capacity (mAh/g) versus Voltage (V vs. Li/Li₊) for cells including non-fluorinated LMR positive electrode materials and cells including fluorinated LMR positive electrode materials.

FIG. 5 is a plot of Voltage (V vs. Li/Li₊) versus differential capacitance dQ/dV (mAh/g/V) for cells including non-fluorinated LMR positive electrode materials and cells including fluorinated LMR positive electrode materials.

In the drawings, reference numbers may be reused to identify similar and/or identical elements.

### DETAILED DESCRIPTION

The presently disclosed fluorinated lithium-rich and manganese-based oxide (LMR) materials can be used as electroactive positive electrode materials in batteries that cycle lithium ions to improve the electrochemical performance therefore, for example, by increasing the specific capacity and columbic efficiency thereof, as compared to batteries that include non-fluorinated LMR materials as electroactive positive electrode materials.

LMR materials have a layered crystal structure with a repeating transition metal (TM) layer, oxygen layer, and lithium (Li) layer. The TM layer comprises transition metal (Me) ions (e.g., Mn ions and Ni ions), the O layer comprises oxygen anions (O²⁻), and the Li layer comprises lithium ions (Li⁺). The fluorine in the presently disclosed fluorinated LMR material may be present in anionic form as F⁻ ions at anion sites in the oxygen layer of the fluorinated LMR material. Without intending to be bound by theory, it is believed that including F⁻ ions at anion sites in the oxygen layer of the presently disclosed fluorinated LMR material may improve the specific capacity and cycling stability of the fluorinated LMR material, for example, by stabilizing the crystal structure of the fluorinated LMR material and preventing the undesirable and irreversible release of oxygen therefrom.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

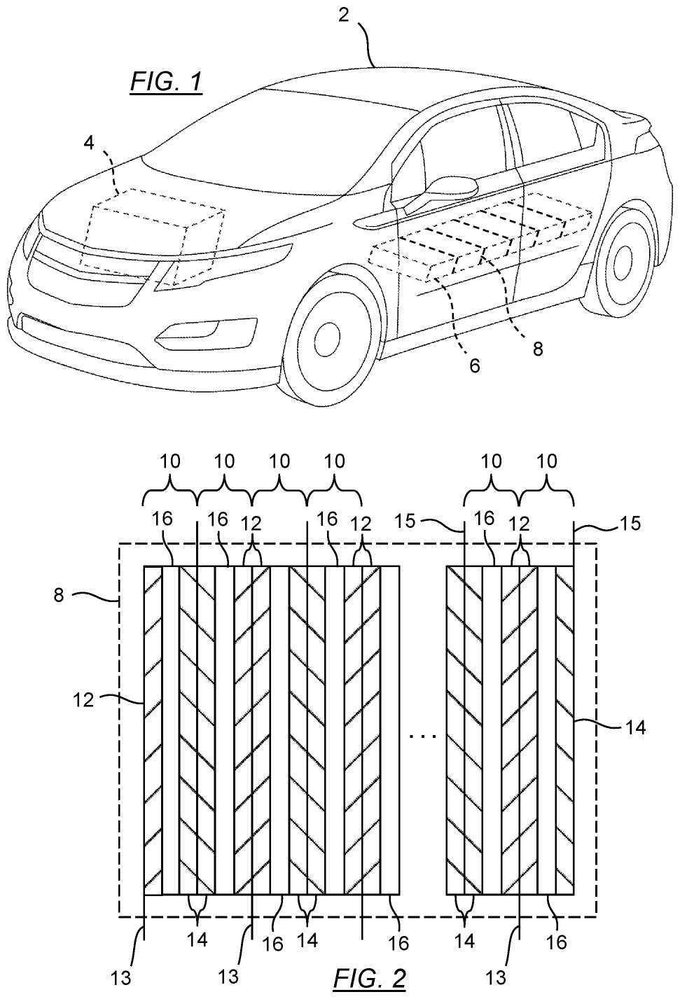

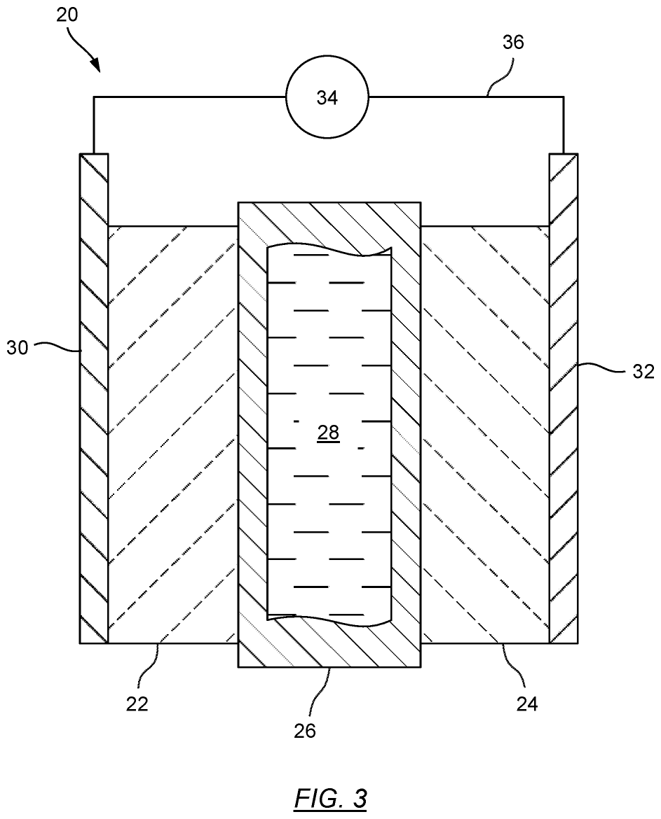

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. In embodiments, the electroactive material of the positive electrode 24 may comprise a high voltage electroactive material formulated to operate at voltages of greater than or equal to 4.4 Volts (V), optionally greater than or equal to 4.5 V, or optionally greater than or equal to 4.6 V, and less than or equal to 5 V versus Li⁺/Li. The electroactive material of the positive electrode 24 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the positive electrode 24.

The electroactive material of the positive electrode 24 comprises an intercalation host material (i.e., a lithium transition metal oxide) that can undergo the reversible insertion or intercalation of lithium ions. More specifically, the electroactive material of the positive electrode 24 comprises a fluorinated lithium-rich and manganese-based oxide (LMR) material. The fluorinated LMR material has the formula (1):

Li₁₊ₓMe₁₋ₓO_{2-y}F_{y}, (1)
where Me is a transition metal selected from the group consisting of Co, Ni, Mn, Fe, Al, V, Mo, Nb, Zr, Zn, Mg, Cu, Ti, and W; Me comprises, on an atomic basis, greater than or equal to 50% Mn; x is greater than 0 and less than or equal to 0.33 (0<x≤0.33); and y is greater than 0 and less than or equal to 0.1 (0<y≤0.1). In embodiments, y may be greater than or equal to 0.005, optionally greater than or equal to 0.01, or optionally greater than or equal to 0.03, and less than or equal to 0.08, or optionally less than or equal to 0.05.

In embodiments, the lithium (Li) may constitute, on an atomic basis, greater than or equal to 25%, or optionally greater than or equal to 28%, and less than or equal to 33%, or optionally less than or equal to 30%, of the fluorinated LMR material of formula (1). The transition metal (Me) may constitute, on an atomic basis, greater than or equal to 16.75%, optionally greater than or equal to 20%, and less than 25%, or optionally less than or equal to 22% of the fluorinated LMR material of formula (1). The oxygen (O) may constitute, on an atomic basis, greater than or equal to 47.5%, or optionally greater than or equal to 48.75%, and less than or equal to 49.98%, or optionally less than or equal to 49.75%, of the fluorinated LMR material of formula (1). The fluorine (F) may constitute, on an atomic basis, greater than or equal to 0.025%, optionally greater than or equal to 0.25%, or optionally greater than or equal to 1%, and less than or equal to 2.5%, optionally less than or equal to 2%, or optionally less than or equal to 1.5%, of the fluorinated LMR material of formula (1).

In embodiments, Me may comprise Mn and Ni. In such case, the manganese (Mn) may constitute, on an atomic basis, greater than or equal to 12.5%, optionally greater than or equal to 15%, and less than or equal to 25%, or optionally less than or equal to 20% of the fluorinated LMR material of formula (1), and the nickel (Ni) may constitute, on an atomic basis, greater than 0%, optionally greater than or equal to 5%, or optionally greater than or equal to 8%, and less than 12.5%, or optionally less than or equal to 10% of the fluorinated LMR material of formula (1).

In embodiments, where Me comprises Mn and Ni, the fluorinated LMR material may have the formula (2):

LiₐNi_{b}Mn_{c}O_{2-y}F_{y}, (2)
where a is greater than or equal to 1.1 and less than or equal to 1.2 (1.1≤a≤1.2); bis greater than or equal to 0.25 and less than or equal to 0.4 (0.25≤b≤0.4); c is greater than or equal to 0.6 and less than or equal to 0.75 (0.6≤c≤0.75); and y is greater than or equal to 0.005 and less than or equal to 0.1 (0.005≤y≤0.1). In embodiments, a may be 1.15, b may be 0.325, c may be 0.675, and y may be greater than or equal to 0.01 and less than or equal to 0.08 (0.01≤y≤0.08).

The fluorinated LMR material may have a layered crystal structure with a repeating transition metal (TM) layer, oxygen (O) layer, and lithium (Li) layer. The TM layer comprises transition metal (Me) ions (e.g., Mn ions and Ni ions) and the O layer comprises oxygen anions (O²⁻). In aspects, the TM layer also may comprise Li⁺ ions. The fluorine in the fluorinated LMR material may be present in anionic form as fluorine ions (F⁻) at anion sites within the O layer of the fluorinated LMR material. In other words, the fluorinated LMR material may be substitutionally doped with the F⁻ ions, with the F⁻ ions replacing O²⁻ ions in the O layer. Without intending to be bound by theory, it is believed that including F-ions at anion sites in the oxygen layer of the presently disclosed fluorinated LMR material may decreases the average anion valence in the O layer and, in turn, lower the counter cation valence in the TM layer in the discharged state, which may increase the redox activity of the Me ions in the TM layer. By decreasing the average anion valence in the O layer, an increased fraction of relatively low-valence redox-active transition metal ions in the TM layer can be achieved, while keeping the excess stoichiometric amount of Li fixed.

In embodiments, in addition to the fluorinated LMR material, the electroactive material of the positive electrode 24 may comprise a non-fluorinated layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In particular, in embodiments, in addition to the fluorinated LMR material, the electroactive material of the positive electrode 24 may comprise spinel phase lithium manganese oxide (LiMn₂O₄, LMO), high voltage spinel phase lithium nickel manganese oxide (LiNi_{0.5}Mn_{1.5}O₄, LNMO), lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂, lithium manganese iron phosphate (LMFP), lithium iron phosphate (LFP), lithium nickel cobalt aluminum oxide (NCA), or a combination thereof.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electroactive material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the negative electrode 22.

In embodiments, the electroactive material of the negative electrode 22 may comprise a silicon oxide-based material (e.g., Si, SiOₓ, and/or Li_{y}SiOₓ) and a carbon-based material (e.g., graphite). In such case, the silicon oxide-based material may constitute, by weight, greater than or equal to 1%, or optionally greater than or equal to 5%, and less than or equal to 70%, optionally less than or equal to 30%, or optionally less than or equal to 10%, of the electroactive material of the negative electrode 22 and the carbon-based material (e.g., graphite) may constitute, by weight, greater than or equal to 30%, optionally greater than or equal to 70%, or optionally greater than or equal to 90%, and less than or equal to 99%, or optionally less than or equal to 95%, of the electroactive material of the negative electrode 22.

In embodiments, the negative electrode 22 may be porous and the electroactive material of the negative electrode 22 may be a particulate material. In embodiments where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts. In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in such embodiments, the negative electrode 22 may be substantially free of a polymer binder.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive and provides a medium for the conduction of lithium ions between the negative electrode 22 and the positive electrode 24. The electrolyte 28 comprises an organic solvent, a lithium salt in the organic solvent, and optionally an additive in the organic solvent.

The organic solvent may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. In aspects, the organic solvent may comprise a mixture of a cyclic carbonate (e.g., FEC) and a linear carbonate (e.g., DMC). The organic solvent may constitute, by weight, greater than or equal to about 80%, or optionally greater than or equal to about 85%, and less than or equal to about 95%, or optionally less than or equal to about 90% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium tetraphenylborate (LiB(C₆H₅)₄), lithium bis(oxalato)borate (LiB(C₂O₄)₂) (LiBOB), lithium difluoro (oxalato) borate (LiBF₂(C₂O₄)) (LiDFOB), and combinations thereof. In aspects, the lithium salt may comprise LiPF₆. The lithium salt may be dissolved in the organic solvent at a concentration of greater than or equal to about 0.5 Molar and less than or equal to about 2 Molar. In aspects, the lithium salt may be dissolved in the organic solvent at a concentration of about 1.2 Molar. The lithium salt may constitute, by weight, greater than or equal to about 5%, optionally greater than or equal to about 10%, and less than or equal to about 20%, or optionally less than or equal to about 15% of the electrolyte 28.

The optional additive is formulated to improve the ionic conductivity of the electrolyte 28 and may help facilitate formation of an electrically insulating and ionically conductive solid electrolyte interphase on surfaces of the electroactive material of the positive electrode 24, which may help improve the cycling stability and capacity retention of the battery 20. The optional additive may comprise lithium difluorophosphate (LiPO₂F₂). When included in the electrolyte 28, the optional additive may constitute, by weight, greater than or equal to 0.1%, or optionally greater than or equal to 0.5%, and less than or equal to 2%, or optionally less than or equal to 1.5% of the electrolyte 28. In embodiments, when included in the electrolyte 28, the optional additive may constitute, by weight, about 1% of the electrolyte 28.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The positive electrode 24 may be manufactured by preparing the fluorinated LMR material, mixing particles of the fluorinated LMR material with the polymer binder, the optional electrically conductive material, and a solvent to form a slurry, depositing the slurry on a substrate, and then removing the solvent therefrom to form the positive electrode 24. The fluorinated LMR material may be manufactured by preparing a non-fluorinated lithium-rich and manganese-based oxide (LMR) material, and then doping the non-fluorinated LMR material with fluorine or a fluorine-containing compound.

The non-fluorinated LMR material may be prepared, for example, using a co-precipitation reaction method in which a transition metal source is mixed with a lithium source to form a mixture, and then the mixture is heated to form a lithium transition metal oxide. The transition metal source may comprise a transition metal carbonate (MeCO₃), a transition metal hydroxide (Me(OH)₂), or a combination thereof. The lithium source may comprise lithium carbonate (Li₂CO₃), lithium carbonate (LiOH), or a combination thereof.

The respective amounts of the transition metal source and the lithium source in the mixture may be selected to achieve the desired proportions of the transition metal(s) and the lithium in the fluorinated LMR material. For example, the amount of the lithium source included in the mixture may be selected such that the ratio of lithium to the transition metal(s) (Li:Me) is greater than 1:1. The mixture may be heated at a temperature of greater than or equal to 250 degrees Celsius (C) and less than or equal to 600° C. for a duration of greater than or equal to 1 hours and less than or equal to 8 hours, and then heated to a temperature of greater than or equal to 700° C. and less than or equal to 1200° C. for a duration of greater than or equal to 12 hours and less than or equal to 24 hours to form the non-fluorinated LMR material. In embodiments, the mixture may be heated at a temperature of 500° C. for a duration of 5 hours, and then heated to a temperature of 900° C. for a duration of 15 hours to form the non-fluorinated LMR material.

The non-fluorinated LMR material may be doped with fluorine or a fluorine-containing compound using a wet chemical method in which a fluorine-containing solution is prepared comprising a fluorine-containing compound dissolved in a solvent, mixing the fluorine-containing solution with the non-fluorinated LMR material to form a precursor mixture, and then removing the solvent from the precursor mixture to form the fluorinated LMR material. The fluorine-containing solution may comprise ammonium fluoride (NH₄F), titanium fluoride (TiF₄), lithium fluoride (LiF), or a combination thereof. The solvent may comprise a polar aprotic organic solvent (e.g., acetone). The fluorine-containing compound may be dissolved in the solvent using a stirrer at 400 rpm on a hot plate at 80° C. to form the fluorine-containing solution. Then, the non-fluorinated LMR material may be added to the fluorine-containing solution to form the precursor mixture. In the precursor mixture, the fluorine in the fluorine-containing solution may react with the non-fluorinated LMR material by replacing some of the oxygen atoms in the crystal lattice of the non-fluorinated LMR material.

The solvent may be removed from the precursor mixture by heating the precursor mixture at a temperature of greater than or equal to 30° C. and less than or equal to 150° C. to form the fluorinated LMR material. In embodiments, the solvent may be removed from the precursor mixture heating the precursor mixture in an oven at a temperature of 80° C. to form the fluorinated LMR material. Then, the fluorinated LMR material may be heated at a temperature of greater than or equal to 300° C. and less than or equal to 600° C. for a duration of greater than or equal to 1 hour and less than or equal to 12 hours to remove chemical reaction byproducts and residual solvent therefrom. For example, in embodiments, the fluorinated LMR material may be heated at a temperature of 450° C. for a duration of 5 hours. In embodiments where the fluorine-containing solution comprises NH₄F, the fluorinated LMR material may be heated to remove ammonium ions (NH₄⁺) therefrom.

### EXPERIMENTAL

Full coin cells including different positive electrode formulations were assembled and evaluated using galvanostatic charge and discharge protocols. All cells included a negative electrode consisting of: an electroactive material consisting of a mixture of 5.5 wt % silicon oxide, graphite, electrically conductive particles, and a polymer binder. All cells included an electrolyte consisting of: 1.2 Molar LiPF₆ in a mixture of FEC and DMC (FEC:DMC=1:4 vol/vol) with 1 wt % LiPO₂F₂. All cells included a positive electrode consisting of: a mixture of electroactive material particles (94 wt %), electrically conductive particles (3 wt %), and a polymer binder (3 wt %). The electroactive material particles in the positive electrodes consisted of: non-fluorinated LMR materials having the formula Li_{1.15}Ni_{0.325}Mn_{0.675}O₂ (non-F LMR), fluorinated LMR materials having the formula Li_{1.15}Ni_{0.325}Mn_{0.675}O_{1.99}F_{0.01} (0.25 at % F-LMR), or fluorinated LMR materials having the formula Li_{1.15}Ni_{0.325}Mn_{0.675}O_{1.95}F_{0.05} (1.25 at % F-LMR).

Cells including non-F LMR positive electrodes, 0.25 at % F-LMR positive electrodes, and 1.25 at % F-LMR positive electrodes were galvanostatically charged and discharged at 25° C. During formation, the cells were charged at a C/20 rate to 4.6 V. Then, a constant current and constant voltage (CCCV) protocol was used to charge the cells at a constant current using a C/3 charge rate to a potential of about 4.6 V, then constant voltage charge at 4.6 V until the current reached C/20. The cells were subsequently discharged at a constant current using a C/3 discharge rate to 2.0 V.

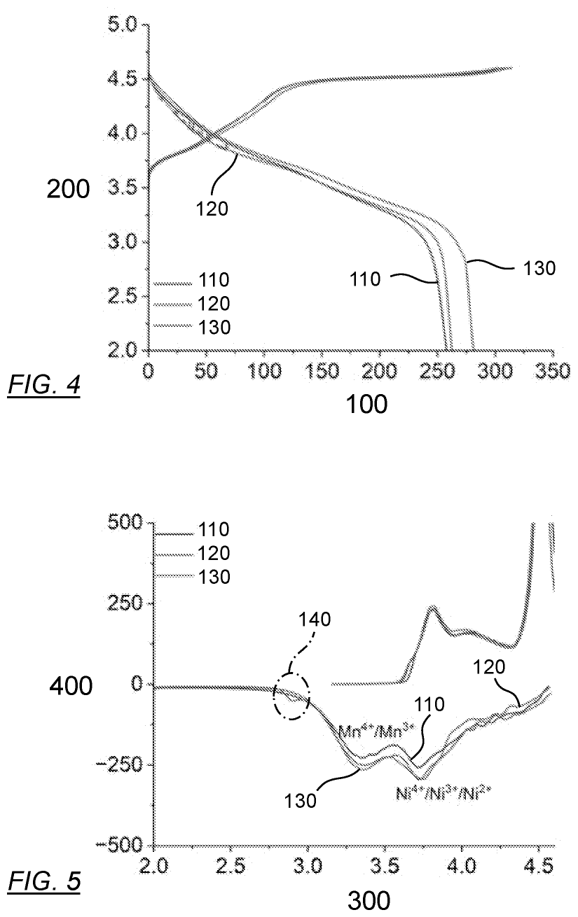

FIG. 4 is a plot of Specific Capacity (mAh/g) 100 versus Voltage (V vs. Li/Li₊) 200 for a cell including the non-F LMR positive electrode (110), a cell including the 0.25 at % F-LMR positive electrode (120), and a cell including the 1.25 at % F-LMR positive electrode (130). As shown in FIG. 4, cells including the F-LMR positive electrodes had high initial discharge capacities and first cycle columbic efficiencies than cells including the non-F LMR positive electrodes (initial discharge capacity increased from 258 mAh/g to 281 mAh/g and first cycle columbic efficiency increased from 83% to 90%).

FIG. 5 is a plot of Voltage (V vs. Li/Li₊) 300 versus differential capacitance dQ/dV (mAh/g/V) 400 for a cell including the non-F LMR positive electrode (110), a cell including the 0.25 at % F-LMR positive electrode (120), and a cell including the 1.25 at % F-LMR positive electrode (130). As shown in FIG. 5, the initial charging capacity of the cells including the non-F LMR positive electrodes and the F-LMR positive electrodes was the same, but during discharge, the Mn⁴⁺/Mn³⁺ and Ni⁴⁺/Ni³⁺/Ni²⁺ redox was higher for the cells including the F-LMR positive electrodes. For example, reduction of Mn⁴⁺ to Mn³⁺ was higher for the cells including the F-LMR positive electrodes. Without intending to be bound by theory, it is believed that the NH₄F solution used to prepare the fluorinated LMR materials of the F-LMR positive electrodes greatly decreases the surface labile lattice oxygen, which results in enhanced surface stability, for example, by combining surface oxygen vacancies, F-doping and the formation of a spinel phase having a coherent structure with the layered phase. As confirmed by the circle 140 in FIG. 5, the higher amount of F in the 1.25 at % F-LMR positive electrode induces the formation of spinel phase on the surface of the 1.25 at % F-LMR positive electrode, for example, via surface reconstruction. Without intending to be bound by theory, it is believed that the high F-content in the 1.25 at % F-LMR positive electrode induces the formation of spinel phase because of Li-deficient on the surface due to more LiF formation along with Me-F.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight.

What is claimed is:

1. A positive electrode for a battery that cycles lithium ions, the positive electrode comprising:
a fluorinated lithium-rich and manganese-based oxide (LMR) material, the fluorinated LMR material having the formula (1):
Li₁₊ₓMe₁₋ₓO_{2-y}F_{y}, (1)
wherein:
Me is a transition metal selected from the group consisting of Co, Ni, Mn, Fe, Al, V, Mo, Nb, Zr, Zn, Mg, Cu, Ti, and W;
Me comprises, on an atomic basis, greater than or equal to 50% Mn;
x is greater than 0 and less than or equal to 0.33; and
y is greater than 0 and less than or equal to 0.1.

2. The positive electrode of claim 1, wherein the y is greater than or equal to 0.005 and less than or equal to 0.08.

3. The positive electrode of claim 1, wherein the fluorinated LMR material has a layered crystal structure including a transition metal layer, an oxygen layer, and a lithium layer, and wherein fluorine ions in the fluorinated LMR material are present at anion sites within the oxygen layer.

4. The positive electrode of claim 1, wherein the fluorinated LMR material has the formula (2):
LiₐNi_{b}Mn_{c}O_{2-y}F_{y}, (2)
wherein:
a is greater than or equal to 1.1 and less than or equal to 1.2;
b is greater than or equal to 0.25 and less than or equal to 0.4;
c is greater than or equal to 0.6 and less than or equal to 0.75; and
y is greater than or equal to 0.005 and less than or equal to 0.08.

5. A battery that cycles lithium ions, the battery comprising:
a negative electrode comprising an electroactive negative electrode material;
a positive electrode comprising a fluorinated lithium-rich and manganese-based oxide (LMR) material, the fluorinated LMR material having the formula (1):
Li₁₊ₓMe₁₋ₓO_{2-y}F_{y}, (1)
wherein:
Me is a transition metal selected from the group consisting of Co, Ni, Mn, Fe, Al, V, Mo, Nb, Zr, Zn, Mg, Cu, Ti, and W;
Me comprises, on an atomic basis, greater than or equal to 50% Mn;
x is greater than 0 and less than or equal to 0.33; and
y is greater than 0 and less than or equal to 0.1; and
an electrolyte infiltrating the positive electrode, the electrolyte comprising an organic solvent and a lithium salt in the organic solvent.

6. The battery of claim 5, wherein the y is greater than or equal to 0.005 and less than or equal to 0.08.

7. The battery of claim 5, wherein the fluorinated LMR material has a layered crystal structure including a transition metal layer, an oxygen layer, and a lithium layer, and wherein fluorine ions in the fluorinated LMR material are present at anion sites within the oxygen layer.

8. The battery of claim 5, wherein the fluorinated LMR material has the formula (2):
LiₐNi_{b}Mn_{c}O_{2-y}F_{y}, (2)
wherein:
a is greater than or equal to 1.1 and less than or equal to 1.2;
b is greater than or equal to 0.25 and less than or equal to 0.4;
c is greater than or equal to 0.6 and less than or equal to 0.75; and
y is greater than or equal to 0.005 and less than or equal to 0.08.

9. The battery of claim 5, wherein the organic solvent comprises fluoroethylene carbonate (FEC) and diethyl carbonate (DEC).

10. The battery of claim 9, wherein the lithium salt comprises lithium hexafluorophosphate (LiPF₆).

11. The battery of claim 10, wherein the electrolyte further comprises lithium difluorophosphate (LiPO₂F₂).

12. The battery of claim 5, wherein the electroactive negative electrode material comprises a silicon oxide-based material and a carbon-based material.

13. The battery of claim 5, wherein the electroactive negative electrode material comprises, by weight, greater than 97% lithium.

14. A method of manufacturing a positive electrode for a battery that cycles lithium ions, the method comprising:
(a) mixing a non-fluorinated lithium-rich and manganese-based oxide (LMR) material with a fluorine-containing solution to form a precursor mixture, the fluorine-containing solution comprising a fluorine compound in a first solvent;
(b) removing the first solvent from the precursor mixture to form a fluorinated lithium-rich and manganese-based oxide (LMR) material, the fluorinated LMR material having the formula (1):
Li₁₊ₓMe₁₋ₓO_{2-y}F_{y}, (1)
wherein:
Me is a transition metal selected from the group consisting of Co, Ni, Mn, Fe, Al, and V;
Me comprises, on an atomic basis, greater than or equal to 50% Mn;
x is greater than 0 and less than or equal to 0.33; and
y is greater than 0 and less than or equal to 0.1;
(c) mixing the fluorinated LMR material with a polymer binder and a second solvent to form a slurry;
(d) depositing the slurry on a substrate; and then
(e) removing the second solvent from the slurry to form the positive electrode.

15. The method of claim 14, wherein the y is greater than or equal to 0.005 and less than or equal to 0.08.

16. The method of claim 14, wherein the fluorine compound comprises ammonium fluoride (NH₄F), titanium fluoride (TiF₄), lithium fluoride (LiF), or a combination thereof.

17. The method of claim 14, wherein the first solvent comprises acetone.

18. The method of claim 14, wherein the first solvent is removed from the precursor mixture by heating the precursor mixture at a temperature of greater than or equal to 30 degrees Celsius and less than or equal to 150 degrees Celsius.

19. The method of claim 14, further comprising:
prior to step (c), heating the fluorinated LMR material at a temperature of greater than or equal to 300° C. and less than or equal to 600° C. for a duration of greater than or equal to 1 hour and less than or equal to 12 hours.

20. The method of claim 14, further comprising:
preparing the non-fluorinated LMR material by mixing a transition metal source with a lithium source to form a mixture; and
heating the mixture to form the non-fluorinated LMR material,
wherein the transition metal source comprises a transition metal carbonate (MeCO₃), a transition metal hydroxide (Me(OH)₂), or a combination thereof, and
wherein the lithium source comprises lithium carbonate (Li₂CO₃), lithium carbonate (LiOH), or a combination thereof.
